(19) United States
(12) Patent Application Publication
(10) Pub. No.: US 2021/0158285 A1
(43) Pub. Date: May 27, 2021

(54) SHIPPING CARTON ASSORTMENT SELECTION

(71) Applicant: Target Brands, Inc., Minneapolis, MN (US)

(72) Inventors: BRIAN AGER, Minneapolis, MN (US); STUART ROGERS, Minneapolis, MN (US); JAKE STREICH, Minneapolis, MN (US)

(21) Appl. No.: 16/840,058

(22) Filed: Apr. 3, 2020

Related U.S. Application Data
(60) Provisional application No. 62/940,707, filed on Nov. 26, 2019.

(51) Int. Cl. G06Q 10/08; G06Q 50/28

(52) U.S. Cl. CPC G06Q 10/0838; G06Q 50/28; G06Q 10/0835; G06Q 10/08345

(57) ABSTRACT

Methods and systems are described for selecting and utilizing an assortment of cartons for shipping items from a facility location are disclosed. A method includes receiving a shipment history for a facility location, and attributes of candidate cartons. For each shipment in the shipment history, a subset of the candidate cartons that can contain the one or more items in each shipment is determined. A cost of shipping is determined for each shipment in each of the possible cartons. An optimal assortment of cartons is selected from the possible cartons based on a cost of shipping and a number of carton types to be included in the assortment.

### CROSS-REFERENCE TO RELATED APPLICATIONS

The present application claims priority from U.S. Provisional Patent Application No. 62/940,707, filed on Nov. 26, 2019, the disclosure of which is hereby incorporated by reference in its entirety.

### TECHNICAL FIELD

The present disclosure is directed to methods and systems for selecting an assortment of cartons for use in shipping items.

### BACKGROUND

Within a supply chain, multiple facilities stock cartons in which items are packaged for shipping. In a supply chain in which a variety of items of different sizes are being shipped, and different combinations of items are shipped from each location within the supply chain, different cartons of varying sizes are used to package those items. Often, some void space is included in each carton even after items are packaged. Minimizing void space results in less wasted space within the carton, less space that the carton takes up during shipping, and reduces the amount of carton material needed to contain items in a shipment. Ideally, each shipment would have a customized amount of space in each carton in order to minimized void space. However, it is not practical to stock cartons of every possible size and shape at each facility in a supply chain. To maximize efficiency, a particular number of cartons may be stocked at each facility. However, it can be difficult to discern which sizes and amounts of each carton should be stocked at a particular facility.

### SUMMARY

In general terms, the present disclosure relates to methods and systems for computationally determining an optimal assortment of cartons to stock at a facility location for shipping items. In particular, the cartons are selected based on shipment histories of one or more facility locations.

At least one aspect of the present disclosure is directed to a method of selecting an assortment of cartons for shipping items from a facility location. The method can include receiving, at a carton selection manager, a shipment history for the facility location, the shipment history including information about a plurality of shipments that were shipped from the facility location over a period of time, wherein each shipment contains one or more items. The method further includes receiving, at the carton selection manager, attributes of candidate cartons, the attributes including at least dimensions, weight, and cost of each of the cartons, and, for each shipment in the shipment history, determining a subset of the candidate cartons that can contain the one or more items in each shipment. The method further includes determining a cost of shipping each shipment in each of the cartons in the subset, determining a number of carton types to include in the assortment of cartons, and selecting an optimal assortment of cartons from the subset of cartons based at least in part on the cost of shipping and the number of carton types. The method further includes communicating instructions to at least one computing system to stock the assortment of cartons at the facility location.

In another aspect, a system for selecting an assortment of cartons for shipping items from one or more retailer locations includes a processing device, a data store comprising order histories, carton attributes, shipping cost information, and item attributes, and a memory device comprising instructions that, when executed by the processing device, implement a carton selection manager. The carton selectin manager is configured to receive shipment histories for the one or more facility locations from the data store, the shipment histories including information about a plurality of shipments that were shipped from the facility locations over a defined period of time, wherein each shipment contains one or more items. The carton selection manager is further configured to receive attributes of candidate cartons from the data store, the attributes including at least dimensions, weight, and cost of each of the cartons, and, for each shipment in the shipment history, determine a subset the candidate cartons that can contain the one or more items in each shipment. The carton selection manager is also configured to determine a cost of shipping each shipment in each of the cartons in the subset, determine a number of carton types to include in the assortment of cartons, and select an optimal assortment of cartons from the subset of cartons based at least in part on the cost of shipping and the number of cartons. The carton selection master is further configured to communicate instructions to at least one computing system to stock the assortment of cartons at the facility location.

In yet another aspect, a non-transitory computer-readable storage medium is disclosed comprising computer-executable instructions which, when executed by a computing system, cause the computing system to perform a method of selecting a carton assortment for a plurality of locations of a retail enterprise. The method includes receiving, at a carton selection manager, a shipment history from a plurality of shipment locations of a retail enterprise, the shipment history including information about a plurality of shipments that were shipped from each of the plurality of locations over a period of time, wherein each shipment contains one or more items. The method also includes receiving, at the carton selection manager, attributes of candidate cartons, the attributes including at least dimensions, weight, and cost of each of the cartons, and, for each shipment in the shipment history associated with a first location of the plurality of locations, determining a first subset of the candidate cartons that can contain the one or more items in the shipment. The method further includes determining first shipping costs associated with each shipment from the first location in each of the determined cartons in the first subset, and selecting, based at least in part on a first predetermined number of cartons to include in the assortment of cartons for the first location and the first shipping costs, a first optimal assortment of cartons from the first subset of candidate cartons. The method also includes, for each shipment in the shipment history associated with a second location of the plurality of locations, determining a second subset of the candidate cartons that can contain the one or more items in the shipment, and determining second shipping costs associated with each shipment from the second location in each of the determined cartons in the first subset. The method also includes selecting, based at least in part on a second predetermined number of cartons to include in an assortment of cartons for the second location and the second shipping costs, a second optimal assortment of cartons from the second subset of candidate cartons. The first optimal assortment of cartons and the second optimal assortment of cartons are differ rent from each other.

### BRIEF DESCRIPTION OF THE DRAWINGS

FIG. 1 illustrates a schematic diagram of an example carton selection manager operating within a retail supply chain.

FIG. 2 illustrates an example block diagram of a computing device useable to implement aspects of the carton selection manager.

FIG. 3 illustrates a more detailed schematic diagram of the carton selection manager and a data store.

FIG. 4 illustrates a flow diagram of an example method of selecting an assortment of cartons for a facility location.

FIG. 5 illustrates a flow diagram of an example method of determining a subset of cartons that can contain each shipment.

FIG. 6 illustrates a diagram showing orientation binary variables for fitting a carton within a box.

FIG. 7 illustrates multiple diagrams showing how nonoverlapping cartons can be oriented to fit within a box.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The term “cartons” can refer generally to any packaging or container having defined dimensions. Thus cartons generally exclude soft-sided materials such as bags and sleeves. For purposes of this disclosure, cartons will generally refer to boxes having defined lengths, width, and heights. The boxes can be made of any material. However, in most cases the boxes will be constructed of a paper-based material such as cardboard.

The term “facility location” generally refers to a particular facility that has, at least in part, a purpose of preparing shipments of items to be shipped in cartons. The facility could be a warehouse, a distribution center, a manufacturing facility, a flow center, or a store room. The facility location could be one of many in a supply chain or be a single facility. In some embodiments, the facility location is a distribution center or retail store within a retail supply chain.

The term “items” refers to objects having defined dimensions that are to be shipped from a facility location to a destination. In some embodiments, the items have a box shape with a length, width, and height. In some embodiments, the items are products for sale within a retail supply chain. In some embodiments, the items can be nested inside one another. In some embodiments, the items must be shipped in a particular orientation. For example, a package of liquid laundry detergent may need to ship upright to avoid leaking its contents during transit. In some embodiments, the items can be deformed for shipping within a container.

Referring generally to the present disclosure, in some example aspects, an assortment of cartons is selected from a set of candidate cartons that minimizes the cost of shipping a set of historical shipments. By selecting a cost-optimal assortment of cartons for shipping online orders, an online retailer can reduce shipping and material (i.e. cardboard, dunnage, and tape) costs. Additionally, the cost-optimized assortment reduces the carton outer volume, quantity of cartons, and weight of materials shipped, thereby reducing the amount of fuel needed to ship the orders.

In example implementations, the assortment selection recommendation process includes determining candidate cartons into which each shipment fits. Numerous fitting algorithms can be utilized, a few of which are described below. The assortment selection recommendation process can further include determining the cost of shipping each shipment in each candidate carton in which the shipment fits. Based on the shipping costs, an assortment of cartons is selected that minimizes shipping costs. The final assortment selection is a p-median problem. The solution to the problem is an assortment of cartons having a defined number of different carton sizes that is stocked at one or more facility locations, for example by maximizing the shipments that will fit within a carton of the selected carton assortment while minimizing shipping costs.

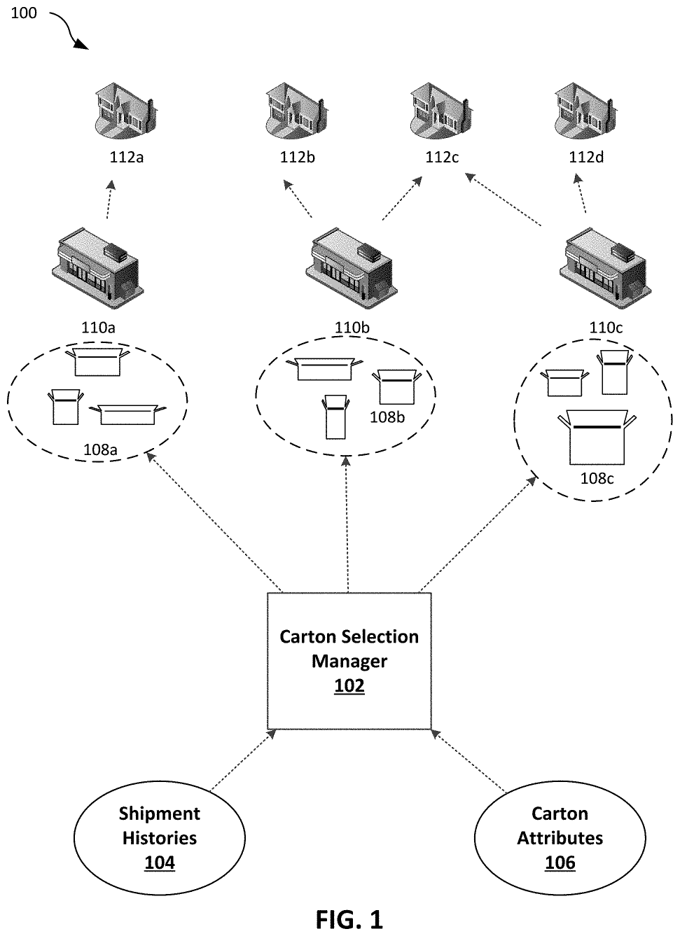

FIG. 1 illustrates a schematic diagram 100 of an example carton selection manager 102 operating within a retail supply chain. In some embodiments, the carton selection manager 102 could operate within other enterprise systems for the purpose of selecting an assortment of cartons for shipping items. Shipment histories 104 and carton attributes 106 are analyzed by the carton selection manager 102 to determine a subset of cartons 108 to stock at each of a plurality of retail facility locations 110. The shipment histories 104 provide details about the attributes of cartons utilized to ship orders of items from the retail locations 110 to various customers 112 as well as the cost of shipping those orders. The carton attributes 106 provide information about dimensions, weights, and weight limits of various cartons available.

In some embodiments, each of the retail locations 110a, 110b, 110c are the same type of facility and each is stocked with the same assortment of cartons. In another example, 110a could be a retail store that receives a first assortment of cartons, 110b is a distribution center that receives a second assortment of cartons, and 110c is another retail store that receives the same assortment cartons as retail location 110a. In yet another example, each of the retail locations 110 receives a unique number and assortment of cartons based on its particular order history. In another example, each retail facility 110 is provided with an assortment of the same number of cartons, but the selection of cartons is different. In example embodiments, retail stores may receive a smaller number of types of cartons (e.g., 10-20 types of cartons, or 12 cartons in some examples) as compared to a distribution center, which may receive a greater number of types of cartons (e.g., 20-40 types of cartons, or 24 cartons in some examples).

In the simplified example of FIG. 1, each retail facility 110 receives an assortment of 3 cartons, but each assortment is unique based on the shipment history of each retail facility 110. Retail facility 110a receives a carton assortment 108 of a small box, a medium box, and a short box. Retail facility 110b receives a carton assortment 108b of a short, wide box, a medium box, and a tall box. Retail facility 110c receives a carton assortment 108c of a medium box, a tall box, and a large box. The retail facility 110a delivers orders to customer 112a. Retail facility 110b delivers orders to customers 112b and 112c. Retail facility 110c delivers orders to customers 112c and 112d. Other retail facilities 110 may deliver orders to, e.g., any of the retail facilities 110a-c (e.g., within the enterprise).

The carton selection manager 102 calculates the space needed to fit all of the items in each shipment of the shipment histories 104 and uses carton attributes 106 to determine which cartons would work. Then it calculates the cost of shipping each order to the customers based on the information in the shipment histories 104. For example, the shipment histories for retail facility 110b would include shipment shipped to customers 112b and 112c. The carton selection manager 102 obtains the item attributes of the items in the shipment that are needed to determine which cartons can contain all of the items in each shipment. Those attributes include height, length, width, and weight. They might include other attributes such as whether an item needs to ship upright or whether the item can nest inside of another item. The carton attributes 106 include the interior dimensions of the carton (height, length, width) as well as the weight capacity of the carton. The cost of the carton itself is also considered. The carton selection manager 102 also solves the p-median problem of selecting which of the possible cartons that can contain the items in the shipments are most cost effective to ship based on the shipment histories 104. Overall, an assortment of cartons is selected for each retail facility 110.

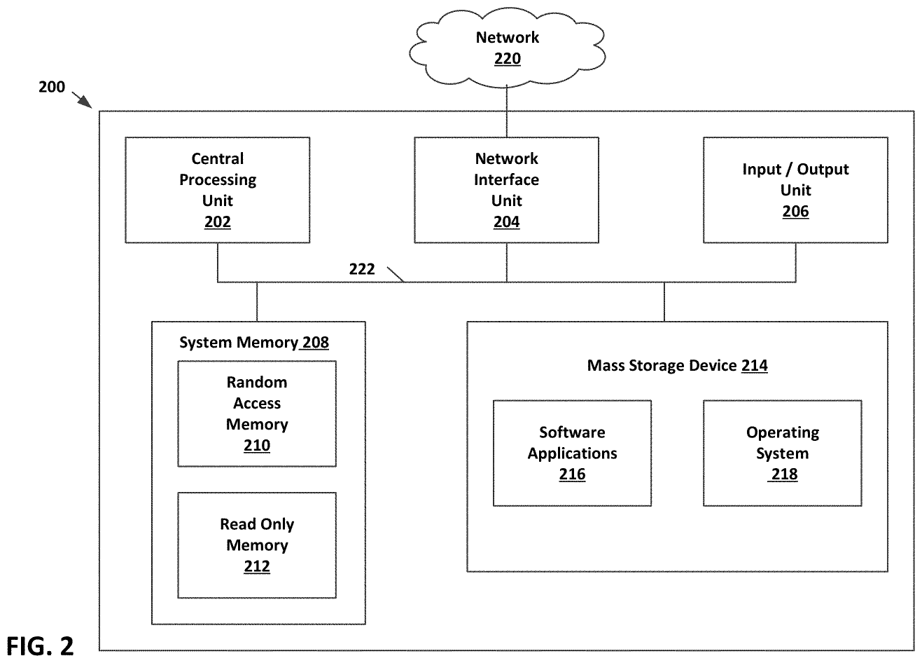

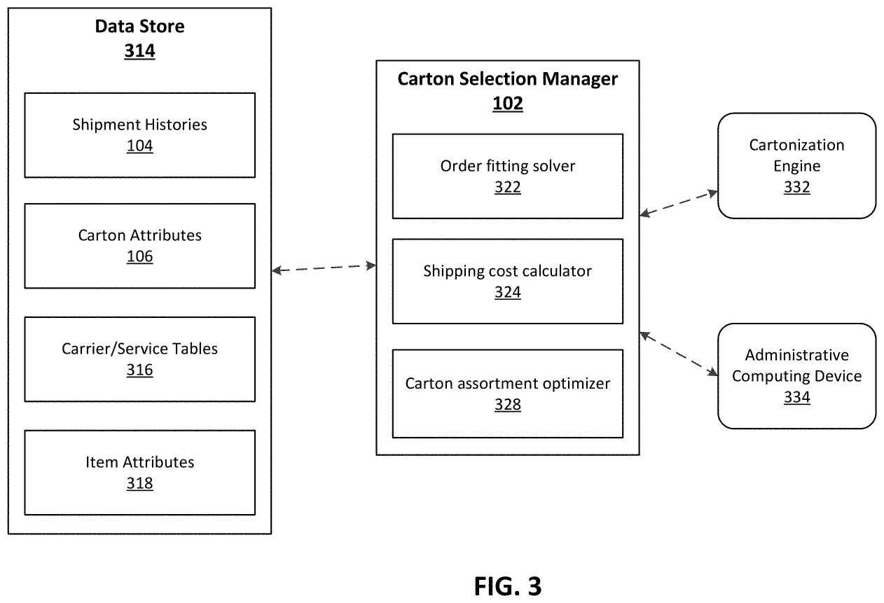

Referring now to FIG. 2, an example block diagram of a computing device 200 is shown that is useable to implement aspects of the system 100 of FIG. 1. For example, the computing device 200 can be used to provide inputs and receive outputs from the carton selection manager 102. The computing device 200 provides one example of the administrative computing device 334 of FIG. 3.

In the embodiment shown, the computing device 200 includes at least one central processing unit (“CPU”) 202, a system memory 208, and a system bus 222 that couples the system memory 208 to the CPU 202. The system memory 208 includes a random access memory (“RAM”) 210 and a read-only memory (“ROM”) 212. A basic input/output system that contains the basic routines that help to transfer information between elements within the computing device 200, such as during startup, is stored in the ROM 212. The computing system 200 further includes a mass storage device 214. The mass storage device 214 is able to store software instructions and data.

The mass storage device 214 is connected to the CPU 202 through a mass storage controller (not shown) connected to the system bus 222. The mass storage device 214 and its associated computer-readable storage media provide non-volatile, non-transitory data storage for the computing device 200. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 202 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 200.

According to various embodiments, the computing device 200 can operate in a networked environment using logical connections to remote network devices through a network 221, such as a wireless network, the Internet, or another type of network. The computing device 200 may connect to the network 221 through a network interface unit 204 connected to the system bus 222. It should be appreciated that the network interface unit 204 may also be utilized to connect to other types of networks and remote computing systems. The computing device 200 also includes an input/output controller 206 for receiving and processing input from a number of other devices, including a touch user interface display screen, or another type of input device. Similarly, the input/output controller 206 may provide output to a touch user interface display screen or other type of output device.

As mentioned briefly above, the mass storage device 214 and the RAM 210 of the computing device 200 can store software instructions and data. The software instructions include an operating system 218 suitable for controlling the operation of the computing device 200. The mass storage device 214 and/or the RAM 210 also store software instructions, that when executed by the CPU 202, cause the computing device 200 to provide the functionality discussed in this document. For example, the mass storage device 214 and/or the RAM 210 can store software instructions that, when executed by the CPU 202, cause the computing system 220 to receive and analyze shipment information for purposes of optimization of a carton assortment, e.g., by implementing a carton selection manager 102 as described herein.

FIG. 3 illustrates a more detailed schematic diagram of the carton selection manager 102. In this example, the carton selection manager 102 is communicatively coupled to a data store 314 including shipment histories 104 and carton attributes 106. In this example, the data store 314 also includes carrier/service tables 316 and item attributes 318. The carton selection manager 102 includes an order fitting solver 322, a shipping cost calculator 324, and a carton assortment optimizer 328. The data store 314 and carton selection manager 102 operate on a computing device such as the computing device 200 of FIG. 2. In some embodiments, the data store 314 is located on a server that is separate from the server on which the carton selection manager 102 operates. In some embodiments, the data store 314 is housed within the same computing device as the carton selection manager 102.

As mentioned above, the shipment histories 104 include information about past shipments originating at each of a plurality of facility locations. In some embodiments, the shipments are orders of items from a retailer to a customer. The items are shipped from a retail facility location such as a distribution center or a retail store to fulfill the customer orders. For each shipment, the data store includes at least identifiers of each of the items in the shipment and a quantity of each item in the shipment. The identifiers can be utilized to access additional information about items within the shipments, such as item dimensions. The shipment histories 104 also include information about the origin and destination of each shipment, identifies a carrier and type of service for each shipment, and provides a total cost of shipping the shipment.

The carton attributes 106 include information about cartons available for selection into assortments for each facility location. Cartons can also be referred to as boxes or containers. For purposes of this specification, cartons will generally mean cardboard boxes of various sizes. Attributes of the cartons can include interior dimensions, exterior dimensions, weight of carton, and cost of carton. In some embodiments, carton attributes can further include a weight capacity.

In some embodiments, carton attributes 106 include information about the costs of cartons and associated materials. These can include the cost of dunnage and tape for preparing cartons for shipping. Dunnage includes materials used to pad items within the carton and fill void space. Examples include packing peanuts, foam fill, paper, bubble wrap, foam wrap, air bags, and absorbent wrap. The cost of cartons can be on a per carton basis. The cost of tape can be provided per unit length, such as inches.

The carrier/service tables 316 provide information about the shipping costs involved in transporting a packed carton from an origin to a destination. Costs are generally provided based on weight and/or volume of cartons.

The item attributes 118 information describes items that are shipped to fulfill orders. Such attributes can include information describing at least some aspects of the items in each shipment or order. In particular, a length, width, and height of each item is recorded. The weight of the item is also recorded. In some embodiments, other information pertinent to constraints on how the item is to be packaged or shipped is recorded. For example, some items containing liquid may need to ship upright, limiting the configurations in which the item can be placed inside of a carton. Some of these item attributes are used to determine whether a particular item or shipment should be excluded from the analysis of the carton selection manager 102.

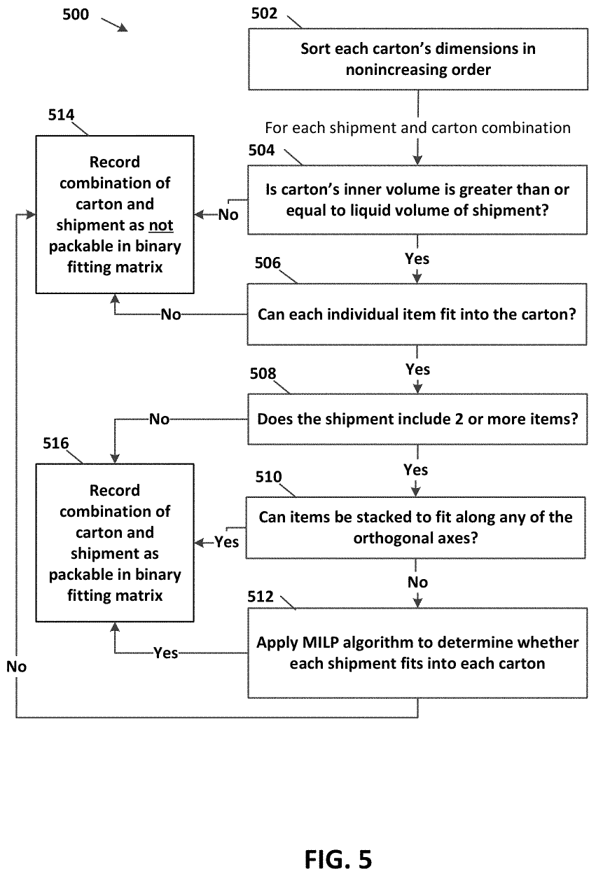

The order fitting solver 322 utilizes the item attributes 318 information and carton attributes 106 information to determine which cartons can hold each shipment of items. This process is described with respect to FIG. 5.

The shipping cost calculator 324 calculates the expected cost of shipping a particular shipments of items in each candidate carton. A cost matrix is constructed for each combination of shipment and carton. Carton attributes 106 and carrier/service tables 316 are utilized as inputs in the calculations.

The carton assortment optimizer 328 synthesizes the information generated by the shipping cost calculator 324 to determine a subset of cartons to stock at each facility location. This p-median problem can be solved using various solvers. One such example is POPSTAR, a freely available p-median problem solver. In some embodiments, the cartons that ship the shipments from the facility location with minimum cost are determined by solving the p-median problem.

In some embodiments, the number of different cartons to be included in a recommendation for a particular location is determined by the carton assortment optimizer 328. In other embodiments, user input provides a restriction on the number of cartons to be stocked at each facility location. The number of cartons could be within a specified range such as, for example, 2-40 cartons, 4-24 cartons, 5-15 cartons, or 8-12 cartons. In some embodiments, a single subset of cartons is selected to be the assortment of cartons stocked at every facility. In some embodiments, each type of facility gets the same number of cartons included in a given recommendation. In some embodiments, the number of cartons stocked at each facility located is determined on a facility by facility basis.

In some embodiments, the carton selection manager 102 communicates information to and from an administrative computing device 334. The administrative computing device 334 can include, for example, the components described in the computing device 200 of FIG. 2. A selection of a number of cartons to stock at a facility can be input at the administrative computing device 334. The administrative computing device 334 can also operate to receive information about a carton assortment from the carton assortment optimizer 328 and display that information on a display of the administrative computing device 334. The information may be a list of carton identifiers as well as a quantity of each type of carton expected to be used at the particular location. The information can be communicated to other computing systems or to employees to implement the carton assortment.

In some embodiments, the carton selection manager 102 outputs carton assortment information to a cartonization engine 332. In particular, the carton assortment selected for each facility is communicated to a cartonization engine 332 so that calculations can be performed to determine the best carton to use to ship each order of items. Every time the carton assortment is updated, the carton assortment information may be communicated to the cartonization engine 332 so that the list of available cartons for use in shipping is updated.

In some embodiments, the cartonization engine 332 is utilized to determine the proper packaging to ship items. The cartonization engine 332 operates to improve the manner in which cartonization occurs for different types of products. For example, for each item, item characteristics are tracked including dimensions. Item attributes are used to determine if a box, bag, mailer, specialty box, or gift is selected. Based on these item characteristics, a package of appropriate size and type is selected.

The cartonization engine 332 can operate to generate a user interface to employees to aid in selecting package size and type for packing orders. The user interface can also illustrate how to place items into a particular package to maximize space within the package.

In some embodiments, an application programming interface (API) (not shown) can operate to communicate information between the carton selection manager 102 and the cartonization engine 332. The API can be published by the carton selection manager 102, and facilitates communications between the carton selection manager 102 and other computing systems that need information about carton assortments.

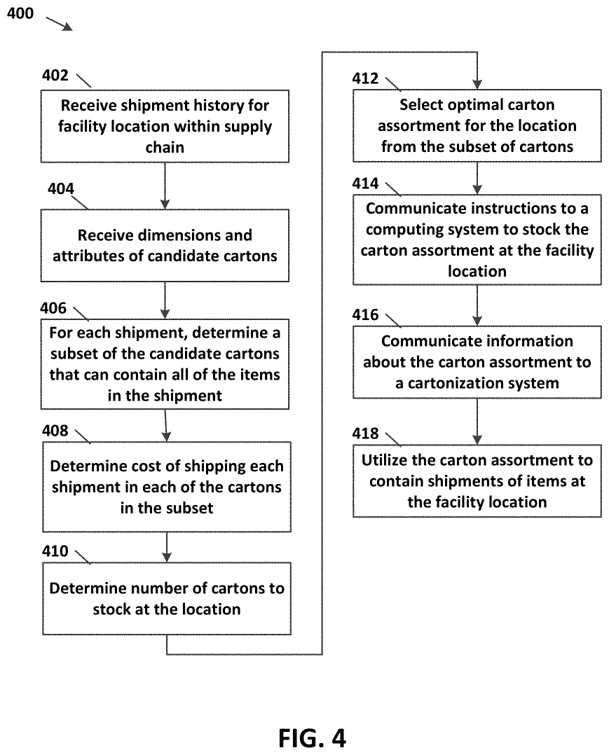

FIG. 4 illustrates a method 400 of selecting an assortment of cartons for a facility location within a supply chain. In some embodiments, the method 400 is performed by the carton selection manager 102 of FIG. 1. The method 400 describes selecting a carton assortment for a single facility location. However, the method 400 could be utilized to select a carton assortment that will be used for multiple facility locations based on shipment histories from each of those facility locations. In some embodiments, the method 400 is repeated periodically to update carton assortments based on more recent shipment history information. For example, a carton assortment for a series of facility locations could be updated on an annual basis.

At operation 402, the shipment history for a facility location within a supply chain is received. In some embodiments, the shipment history is received at the carton selection manager 102 from the data store 314. The shipment history includes information about the items in each shipment as well as the destination of each shipment.

At operation 404, dimensions and attributes of candidate cartons are received. In some embodiments, the dimensions and attributes are received at the carton selection manager 102 from the data store 314. The dimensions of the candidate cartons include interior length, width, and height of each carton as well as exterior length, width, and height. The attributes of the candidate cartons include at least a weight of each carton. Attributes can also include the cost of the cartons and associated packing materials.

At operation 406, it is determined for each shipment, which of the candidate cartons can contain all of the items in the shipment. This can include calculating an interior volume of the candidate cartons, and determining which candidate cartons are eligible to fit all items in a shipment by volume. In some embodiments, this operation also utilizes the order fitting solver 322 using data from the shipment histories 104, carton attributes 106, and item attributes 318. In some embodiments, a MILP solver is utilized. The process for determining this is described in further detail with respect to FIG. 5.

At operation 408, a cost of shipping is determined for each shipment in each of the candidate cartons that can contain all of the items in the shipment. After the shipments that could not be packed into any candidate carton are removed, a nonnegative shipping cost matrix C is constructed. The matrix records shipping costs for each combination of carton and shipment. The cost to ship and given shipment in a given carton may be determined, in some examples, by the following, where i represents the shipment and j the carton:

$${C}_{ij} = {ω}_{{s}_{i}} ( max \{ ⌈ {χ}_{{s}_{i} j} [ {L}_{j} ] [ {W}_{j} ] [ {H}_{j} ] ⌉ , ⌈ {Q}_{j} + {q}_{i} ⌉ \} , {ζ}_{i} ) + ⌊ \frac{{\tilde{V}}_{j} - {v}_{i}}{ψ} ⌋ φ + {D}_{j} .$$

In the above, sᵢ represents the carrier/service combination for a given shipment, ωₛᵢ represents a lookup table giving cost to ship that shipment i in box j from source to destination as a function of billable weight and shipping zone. Lⱼ, Wⱼ, and Hⱼ are outer dimensions, Qⱼ is the weight of the carton, Dⱼ is the cost of the carton, \tilde{V}ⱼ is the inner volume, and Vⱼ is the outer volume of the carton. Qᵢ and vᵢ are the weight and liquid volume of the shipment i. The maximum term determines a maximum of the dimensional weight (as determined by carton dimensions and liquid weight). The inner volume terms are used to calculate potential void space within the carton, to calculate cost of air pillows that may be used to protect and stabilize shipped items within the carton; the second cost term corresponds to a dunnage cost upper bound (with the ϕ term corresponding to cost of an air pillow used in the carton). Accordingly, it can be seen that overall cost used in the cost matrix generally corresponds to an aggregate of the cost of shipment between designated zones for a particular shipment, dunnage costs, and carton costs.

To arrive at the weight of the carton, in some examples Qⱼ is determined from an area of flat corrugated material used in the carton as multiplied by a constant weight per unit area of the material used. Cost of the carton Dⱼ can be arrived at by using a cost of the corrugated material used to construct the carton, cost of tape used to tape the carton together/closed, and a cost to transport the carton to the location at which it will be used. Additionally, entries for each combination of carrier and service level can be included.

After the cost of shipping is calculated for each combination, the results are recorded in the shipping cost matrix. In some embodiments, this operation is performed by the shipping cost calculator 324 using data from the carton attributes 106 and carrier/service lookup tables 316.

At operation 410, a number of carton types or sizes to stock at the facility location is determined. In some embodiments, the number of carton types is determined by a user of the administrative computing device 334. In some embodiments, the number of carton types is determined by the carton selection manager 102 based on the calculations performed in operations 406, 408, and 412. In some embodiments, a range of number of carton types is determined by a user of the administrative computing device 334.

At operation 412, an optimal carton assortment for the location is selected from the subset of cartons. In some embodiments, this operation is performed by the carton assortment optimizer 328 using the information in the shipping cost matrix C and the acceptable number of carton types designated for the location. The number of cartons in the carton assortment is determined in operation 410. In some embodiments, the optimal carton assortment is selected for multiple facility locations based on their combined shipment histories. Optimal carton selection is a p-median problem. The process of setting up and solving the p-median problem is described in greater detail below. In general, a p-median problem is solved by assessing: given a particularized set of customers and a further set of candidate facilities, a nonnegative cost of serving each customer with each candidate facility is assessed with a fixed number of solutions, and a solution that represents a selection that minimizes the sum of costs of serving each customer with its minimum cost open facility. In this context, the customers are shipments, while the open facilities represent available carton types.

At operation 414, instructions are communicated to a computing system to stock the carton assortment at the facility location. In some embodiments, the computing system is the administrative computing device 334. In other embodiments, the computing system is operated by one or more employees tasked with the job of stocking cartons at one or more facility locations. A list of cartons can be printed or viewed on a graphical user interface.

At operation 416, information about the carton assortment is optionally communicated to a cartonization system. In some embodiments, the cartonization system is the cartonization engine 332 of FIG. 3. The carton assortment is used to generate cartonization recommendations for packaging items for shipments prepared at the facility locations. In some embodiments, the cartonization instructions instruct an employee how to pack a shipment of items into a carton.

At operation 418, the carton assortment is utilized to contain shipments of items at the facility location. This can include, for example, applying the carton assortment to a future set of shipments of items from the facility location. Given an assumption that future shipments will be relatively well represented by the set of past shipments used for assessment, it is expected that application of the carton assortment to such future shipments will reduce the amount of packing material and shipping cost that will be required.

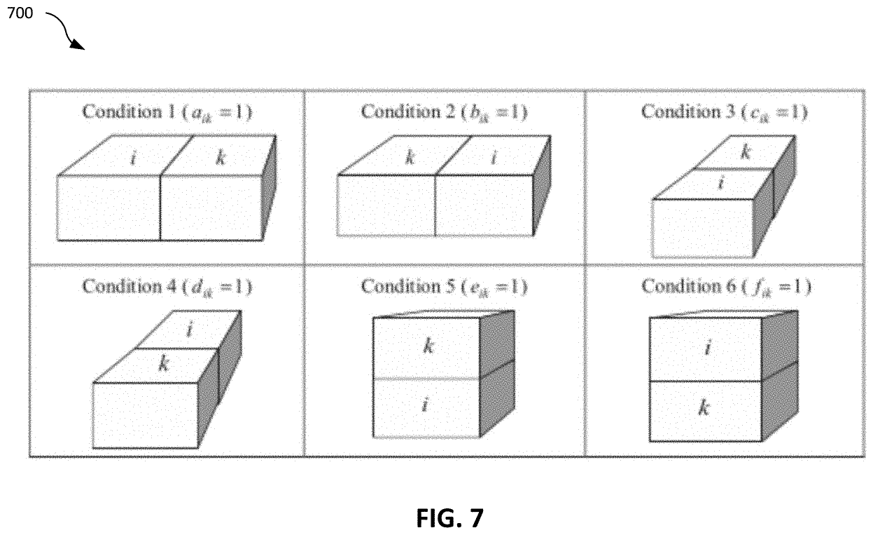

FIG. 5 illustrates a more detailed method 500 of the process of operation 406 from FIG. 4. A subset of candidate cartons that can contain all of the items in each shipment is determined. An even more detailed series of operations for completing this method 500 is provided below after the description of FIG. 7. In this context, the number of candidate cartons must be greater than the number of cartons that will be selected for the assortment. For example, there could be 50 possible cartons and the final assortment is specified to have 25 cartons.

At operation 502, each candidate carton's dimensions are sorted in nonincreasing order. For example, a three-dimensional box size will have its x, y, z dimensions (e.g., inner volumetric dimensions) resorted such that a largest dimension appears first in order. Additionally, in some examples (such as described in the detailed algorithm outlined below), it is determined, for each candidate carton, the other candidate cartons into which the candidate carton can nest. This can include, for example, calculating a volume of each candidate carton as well as assessing relative dimensions to determine whether such fitting is possible.

Once the characteristics of candidate cartons are determined, for each shipment, an analysis may be performed to determine (1) the type of carton that can receive a given shipment, and (2) an optimized assortment of carton types that can accommodate the historical shipments for a particular retail location. The optimization may be performed based on overall cost of shipments, overall coverage (e.g., minimizing the number of shipments that cannot be accommodated), or both/other factors.

At operation 504, it is determined, for each given shipment and carton, whether the carton's inner volume (e.g., as determined in operation 502) is greater than or equal to the shipment's liquid volume. The shipment's liquid volume is the total volume of all items in the shipment. If the total volume of the items in the shipment exceeds the inner volume of the carton, the items of that particular shipment will not fit into that particular carton and the method proceeds to operation 514, discussed below. However, if the total volume of the items does not exceed the inner volume of the carton, the method proceeds to operation 506.

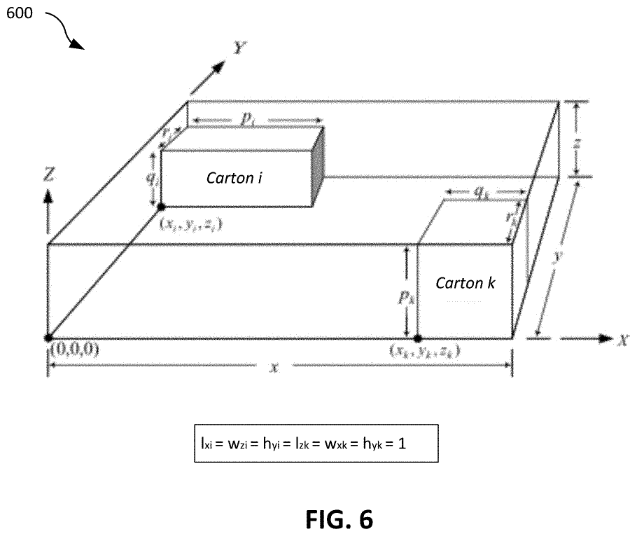

At operation 506, it is determined if the dimensions of each individual item in the shipment are smaller than the interior dimensions of carton. This can apply by aligning the item along any of the orthogonal axes of the carton. FIG. 6 illustrates a diagram 600 how this can be done. If so, the item fits into the carton and the method proceeds to operation 508. If not, the item does not fit and the method proceeds to operation 514.

At operation 508, it is determined whether the shipment includes two or more items. If so, the method proceeds to operation 510. If not, the single item has already been determined to fit into the carton and the result is recorded as packable in the binary fitting matrix at operation 516.

At operation 510, since it has been determined that two or more items are included in the shipment, it is determined whether the items in the shipment can be stacked to fit along any of the orthogonal axes of the carton. Various orientations of the items can be examined, as shown in the diagram 700 of FIG. 7. If the problem of fitting the items of the shipment into the carton can be solved by stacking, the method proceeds to operation 516. If stacking does not solve the problem, the method proceeds to operation 512.

At operation 512, a fitting mixed-integer linear program (MILP) is utilized to solve the fitting problem. A detailed example of utilizing a MILP for fitting is provided below. If the algorithm determines that all of the items in the shipment can fit into the carton, the method proceeds to operation 516. If not, the method proceeds to operation 514.

At operation 514, the combination of carton and shipment is recorded in the binary fitting matrix as not packable. This indicates that the items of the shipment do not all fit into the specified carton.

At operation 516, the combination of carton and shipment is recorded in the binary fitting matrix as packable. This indicates that the items of the shipment can fit into the specified carton. In some instances, additional void space may be present.

FIG. 6 shows an example diagram 600 illustrating the operation of the MILP problem for fitting shipments into cartons. Generally speaking, the fitting MILP solver determines, in the context of this carton selection process, whether n∈N rectangular cartons, with positive outer lengths, widths, and heights, fit in a box with positive inner length, width, and height, permitting orthogonal rotations of each carton. When packed into the box, it is assumed that a carton's edges must be parallel to those of the box, so that there are 6 possible orthogonal rotations of each carton.

A right-handed orthogonal 3D cartesian coordinate system is used as the box's frame. The X-axis is parallel to the box length x, the Y-axis is parallel to the box width y, and the Z-axis is parallel to the box height z. The axes intersect orthogonally at (0, 0, 0), which coincides with the left-back-bottom (lbb) corner of the box. Left to right is along the X-axis with 0 on the left and x on the right. Back to front is along the Y-axis with 0 at the back and y at the front. Bottom to top is along the Z-axis with 0 at the bottom and z at the top. Whether the cartons fit into the box can be determined by checking the feasibility (or satisfiability) of a set of linear inequality constraints depending on a set of continuous and binary variables. These constraints and variables form a feasibility MILP called the fitting MILP. Since any feasibility MILP is NP-complete (can be solved in polynomial time only using a non-deterministic method), the fitting MILP is NP-complete.

In addition, a number of constraints are applied to the MILP, including orientation constraints, containment constraints, non-overlapping constraints, and symmetry constraints. Although discussed in further detail below, the orientation constraints generally define the way in which a particular shipment may fit within a candidate carton. There are generally 9 orientation binary variables that indicate which of 6 different ways a carton may be oriented. However, in some example implementations, certain additional constraints are applied at this stage. For example, a particular shipment may be designated as “height-orientation-restricted” meaning that it may only be fit within a carton in one of two “upright” orientations. This may be applied to designated item types, e.g., liquid items. Additionally, some items may also be required to be packed such that the rest on the base of the carton (i.e., cannot be stacked on top of another shipped item within the carton).

The containment constraints generally require each shipment to be placed within the boundaries of the carton being considered as a candidate for use. Additionally, the non-overlapping constraints prevent shipments from occupying a common space within the carton, in the MILP. The symmetry constraints ensure that identical cartons are considered in a consistent order, and symmetry-breaking constraints may be included to require a feasible packing order. Further regarding example constraints are provided below in conjunction with a detailed example.

Upon implementation of the constraints described above, a solver may be applied. Various solvers may be used. For example, Gurobi, CPLEX, MIPCL, and CBC solvers may be used.

As seen in the diagram 600, x, y, z are positive variables for length, width, and height of the containing box. pᵢ, qᵢ, rᵢ are parameters indicating the length, width, and height of the carton i, shown in FIG. 6. xᵢ, yᵢ, zᵢ are positive variables for the left-back-bottom corner of carton i. lₓᵢ, l_{yi}, l_{zi} are binary variables indicating whether the length of carton i is parallel to the X, Y, or Z axis. wₓᵢ, w_{yi}, w_{zi} are binary variables indicating whether the width of carton i is parallel to the X, Y, or Z axis. hₓᵢ, h_{yi}, h_{zi} are binary variables indicating whether the height of carton i is parallel to the X, Y, or Z axis. lₓᵢ=w_{zi}=h_{yi}=l_{zk}=wₓₖ=h_{yk}=1.

Now referring to FIG. 7, a diagram 700 illustrates the various conditions applicable to fitting cartons inside of boxes, used as part of solving the MILP problem discussed above. Such conditions may include, for example:

aᵢₖ=1 if carton i is left of carton k (condition 1), otherwise

aᵢₖ=0. bᵢₖ=1 if carton i is right of carton k (condition 2), otherwise

bᵢₖ=0. cᵢₖ=1 if carton i is behind carton k (condition 3), otherwise

cᵢₖ=0. dᵢₖ=1 if carton i is in front of carton k (condition 4), otherwise

dᵢₖ=0. eᵢₖ=1 if carton i is below carton k (condition 5), otherwise

eᵢₖ=0. fᵢₖ=1 if carton i is above carton k (condition 6), otherwise

fᵢₖ=0.

These conditions may be used in the MILP solver to define the existence of specific relative orientations to define possible solutions.

### Detailed Algorithm Example

Referring to FIGS. 1-7, above the following illustrate a detailed example algorithm for generating a carton assortment recommendation. In accordance with this example, the algorithm assumes that an online retailer needs an assortment of p∈N boxes (cartons) to ship its online customer orders. Moreover, k∈{0}∪ [symbol] p−1 [symbol] ={0, . . . , p−1} boxes in the suite may be prescribed (or locked). For example, the online retailer may need some special boxes for shipping liquid items such as liquid detergent. Generally, the online retailer will want such a suite that minimizes total material cost.

One approach to designing this suite is to select I∈N historical customer shipments and J∈N candidate boxes, where J>p. Each historical customer shipment is assigned a unique index i∈I, and each candidate box is assigned a unique index j∈J. The set of historical customer shipments should be a small, but statistically significant, randomly sampled subset of the online retailer's past (e.g. within the previous year) online customer shipments. Each historical customer shipment i∈I consists of Nᵢ ∈N₀ rectangular cartons with positive outer lengths, widths, and heights {(pᵢₙ, gᵢₙ, rᵢₙ)}^{Ni} where (p_{i,n}, q_{i,n}, r_{i,n})∈R³ for i∈I and n∈Nᵢ, and Mᵢ∈N₀ foldable objects with positive outer lengths, widths, and heights [(sᵢₘ, tᵢₘ, uᵢₙ)}·ₘ₌₁^{M}^{ᵢ}, where (sᵢₘ, tᵢₘ, uᵢₘ)∈ [symbol] _{>0}³ for i∈ [symbol] I [symbol] and m∈ [symbol] Mᵢ [symbol] with [symbol] x [symbol] ={1, . . . , x}. For the purposes of packing, foldable objects are assumed to be liquid so that they may be deformed to fit into arbitrarily-shaped empty spaces inside a box.

The set of J candidate boxes should finely discretize the space of all possible boxes and must include the k locked boxes that must be in the suite. The indices of those k locked boxes are prescribed in the subset T⊂[J], where |T|=k. Each candidate box j∈[J] is characterized by a positive inner length, width, and height (xⱼ, yⱼ, zⱼ)∈R_{>0}³. Therefore, the inner volume of candidate box j∈[J] is V=xyz∈. It is assumed that the candidate boxes are sorted by nondecreasing inner volume, which may be realized in O (J log J), so that [symbol] ≤ [symbol] +1 for j∈J−1. The optimal suite is obtained by selecting a subset S⊂J of the J boxes, such that |S|=p and T⊂S, that ships the Î packable shipments, where Î≤I (since not all of the I shipments necessarily fit in the J candidate boxes), with minimum cost. Below, Table 1 includes a description of Algorithm 1, which is an example of a detailed implementation of the process described herein:

TABLE 1
Box Suite Recommendation Example Implementation
Algorithm 1 Box Suite Recommendation

Input: Box suite size p. I shipments. Each shipment i ∈ [symbol] I [symbol] consists of Nᵢ rectangular cartons with outer
lengths, widths, and heights {(pᵢₙ, qᵢₙ, rᵢₙ)}ₙ₌₁^{N}^{ᵢ} and Mᵢ foldable objects with outer lengths, widths, and heights
{(sᵢₘ, tᵢₘ, uᵢₘ)}ₘ₌₁^{M}^{ᵢ}. J candidate boxes, where J > p, sorted by nondecreasing inner volume with inner lengths,
widths, and heights {(xⱼ, yⱼ, zⱼ)}ⱼ₌₁^{J} and inner volumes {Vⱼ = xⱼyⱼzⱼ}ⱼ₌₁^{j}. For j ∈ [symbol] J − 1 [symbol] , Vⱼ ≤ Vⱼ₊₁. A subset
T ⊂ [symbol] J [symbol] of the candidate boxes, where |T| = k ∈ {0, 1, 2, . . . , p − 1}, must be in the box suite.
Output: A subset S* ⊂ [symbol] J [symbol] of the candidate boxes such that S* ships all the packable shipments with minimum
cost, subject to the constraints |S*| = p and T ⊂ S*. If such a subset does not exist, then Ø is returned.

| | | |
|---|---|---|
| 1: | for j = 1 to J do | [symbol] Iterate over candidate boxes. |

| | | |
|---|---|---|
| 2: | (\tilde{x}ⱼ, \tilde{y}ⱼ, \tilde{z}ⱼ) ← SORT (xⱼ, yⱼ, zⱼ) | [symbol] Sort box inner dimensions in nonincreasing order. |

| 3: | end for | |
|---|---|---|
| | [symbol] Determine into which candidate boxes each candidate box nests | |
| 4: | for j = 1 to J do | [symbol] Iterate over candidate boxes. |

| | | |
|---|---|---|
| 5: | Θⱼ ← {j} | [symbol] Θⱼ stores the set of boxes into which box j nests. |

| | | |
|---|---|---|
| 6: | for k ← j + 1 to J do | [symbol] Iterate over equal or larger volume candidate boxes. |

| | | |
|---|---|---|
| 7: | if (\ddot{x}ⱼ ≤ \ddot{x}ₖ) ∧ (ŷⱼ ≤ ÿₖ) ∧ (\tilde{z}ⱼ ≤ \hat{z}ₖ) then | [symbol] If box j nests inside box k. |

| | |
|---|---|
| 8: | PUSH (Θⱼ, k) |

| | |
|---|---|
| 9: | end if |

| | |
|---|---|
| 10: | end for |

| | |
|---|---|
| 11: | end for |

[symbol]

Construct the I × J fitting matrix B and determine the packable shipments.

| | | |
|---|---|---|
| 12: | Î ← 0 | [symbol] Initialize the number of packable shipments to 0. |

| | | |
|---|---|---|
| 13: | W ← Ø | [symbol] W stores the indices of shipments that are packable. |

| | | |
|---|---|---|
| 14: | B ← 0_{I×J} | [symbol] Initialize each entry of the fitting matrix to zero. |

| | | |
|---|---|---|
| 15: | for i = 1 to I do | [symbol] Iterate over shipments. |

| | | |
|---|---|---|
| 16: | vᵢ ← Σₙ₌₁^{N}^{ᵢ} pᵢₙqᵢₙrᵢₙ + Σₘ₌₁^{M}^{ᵢ} sᵢₘtᵢₘuᵢₘ | [symbol] Liquid volume of shipment i. |

| | | |
|---|---|---|
| 17: | j₀ ← SEARCHSORTEDFIRST ({Vⱼ}ⱼ₌₁^{J}, vᵢ) | [symbol] Find the smallest box whose inner volume ≥ vᵢ. |

| | | |
|---|---|---|
| 18: | if j₀ = J + 1 then continue | [symbol] This shipment does fit into any box, so skip to the next shipment. |

| 19: | end if | |
|---|---|---|
| 20: | if Nᵢ = 0 then | [symbol] Only foldable objects in the shipment. |

| 21: | B_{i{j}_{₀}_{;J}} ← 1_{1×{J-j}_{₀}_{+1}} | |
|---|---|---|
| 22: | continue | [symbol] Skip to the next shipment. |

| 23: | end if | |
|---|---|---|
| 24: | for n = 1 to Nᵢ do | [symbol] Iterate over cartons in shipment i. |

| | | |
|---|---|---|
| 25: | (\tilde{p}ᵢₙ, \tilde{q}ᵢₙ, \tilde{r}ᵢₙ) ← SORT (pᵢₙ, qᵢₙ, rᵢₙ) | [symbol] Sort carton outer dimensions in nonincreasing order. |

| | |
|---|---|
| 26: | end for |
| 27: | \hat{p}ᵢ ← Σₙ₌₁^{N}^{ᵢ} \tilde{p}ᵢₙ \hat{q}ᵢ ← Σₙ₌₁^{N}^{ᵢ} \tilde{q}ᵢₙ \hat{r}ᵢ ← Σₙ₌₁^{N}^{ᵢ} \ddot{r}ᵢₙ |
| 28: | \hat{p}ᵢ ← max_{1≤n≤N}, \tilde{p}ᵢₙ \hat{q}ᵢ ← max_{1≤n≤N}, \tilde{q}ᵢₙ \hat{r}ᵢ ← max_{1≤n≤N}, \tilde{r}ᵢₙ |

| | | |
|---|---|---|
| 29: | for j = j₀ to J do | [symbol] Iterate over candidate boxes whose inner volume ≥ vᵢ. |

| | | |
|---|---|---|
| 30: | if Bᵢⱼ = 1 then continue | [symbol] Skip to the next candidate box. |

| | | |
|---|---|---|
| 31: | else if (\hat{p}ᵢ ≤ \tilde{x}ⱼ) ∧ (\dot{q}ᵢ ≤ ŷⱼ) ∧ (\dot{r}ᵢ ≤ \hat{z}ⱼ) then | [symbol] Each carton in shipment i must fit in box j. |

| | | |
|---|---|---|
| 32: | if Nᵢ = 1 then B_{iΘ}_{ᵢ} ← 1_{1×[Θ}_{ⱼ}_{]} | [symbol] Only 1 carton in the shipment. |

| | | |
|---|---|---|
| 33: | else if (\check{p}ᵢ ≤ \tilde{x}ⱼ) ∨ (\hat{q}ᵢ ≤ \tilde{y}ⱼ) ∨ (\hat{r}ᵢ ≤ \tilde{z}ⱼ) then B_{iΘ}_{ⱼ} ← 1_{1×[Θ}_{ᵢ}_{]} | [symbol] Try stacking. |

| | |
|---|---|
| | [symbol] Solve the NP-complete fitting MILP, e.g. with CPLEX or Gurobi. |
| 34: | else if FITTINGMILP ({(pᵢₙ, qᵢₙ, rᵢₙ)}ₙ₌₁Ni, (xⱼ, yⱼ, zⱼ)) then B_{iΘ}_{ⱼ} ← 1_{1×[Θ}_{ᵢ}_{]} |
| 35: | end if |

| | |
|---|---|
| 36: | end if |

| 37: | end for | |
|---|---|---|
| 38: | if Vⱼ₌₁^{J} Bᵢⱼ = 1 then | [symbol] Ignore shipments that cannot be packed into any candidate box. |

| | | |
|---|---|---|
| 39: | Ĩ = Ĩ + 1 | [symbol] Ĩ stores the number of packable shipments encountered so far. |
| 40: | J_{I} ← {j ∈ [symbol] J [symbol] : Bᵢⱼ = 1} | [symbol] Find the subset of candidate boxes into which shipment i fits. |

| | | |
|---|---|---|
| 41: | PUSH (W, i) | [symbol] Add shipment i to the set of packable shipments. |

| | |
|---|---|
| 42: | end if |

| 43: | end for | |
|---|---|---|
| | [symbol] Construct the (Î + k) × J cost matrix C. | |
| 44: | C ← 0_{(I+k)×J} | [symbol] Preallocate memory for a Î = k by J cost matrix. |

| | | |
|---|---|---|
| 45: | for i = 1 to Î do | [symbol] Iterate over packable shipments. |

| | | |
|---|---|---|
| 46: | for j ∈ J, do | [symbol] Iterate over the subset of candidate boxes into which packable shipment i fits. |

| | |
|---|---|
| 47: | Compute the cost Cᵢⱼ of shipping packable shipment i (shipment Wᵢ) in candidate box j. |

| | |
|---|---|
| 48: | end for |

| 49: | end for | |
|---|---|---|
| 50: | Γ ← [Σᵢ₌₁^{I} max_{j∈J}_{ᵢ} Cᵢⱼ] + 1 | [symbol] Set Γ to ⊗ or a sufficiently large positive real number. |

| | | |
|---|---|---|
| 51: | for i = 1 to Î do | [symbol] Iterate over packable shipments. |

| | | |
|---|---|---|
| 52: | C_{i[J\J}_{ᵢ}_{]} ← Γ_{1×(J-\|J}_{ᵢ}_{\|)} | [symbol] Packable shipment i ships with infinite cost in boxes into which it does not fit. |

| 53: | end for | |
|---|---|---|
| 54: | for i = Î + 1 to Î + k do | [symbol] Iterate over fake shipments. |

| | | |
|---|---|---|
| 55: | C_{iT}_{_{i−I}} ← 0 | [symbol] Fake shipment i ships for free in box T_{i-I}. |

| | | |
|---|---|---|
| 56: | C_{i[J\{T}_{_{i−I}}_{}]} ← Γ_{1×(J-1)} | [symbol] Fake shipment i ships with infinite cost in all other boxes. |

| 57: | end for | |
|---|---|---|
| 58: | ${S}^{x} ← {arg min}_{S ⋐ [ J ] , \vert S \vert = p} {\sum }_{i = 1}^{\hat{I} + k} {min}_{j ∈ S} {C}_{ij}$ | [symbol] Solve the NP-hard p-median problem, e.g. with POPSTAR. |

| | | |
|---|---|---|
| 59: | Φ ← Σᵢ₌₁^{I+k} min_{j∈S}, Cᵢⱼ | [symbol] Compute the cost of using S* to ship the packable shipments. |

| | |
|---|---|
| 60: | if Φ ≥ Γ then |

| | | |
|---|---|---|
| 61: | return Ø | [symbol] There is no feasible solution, so return the empty set. |

| | |
|---|---|
| 62: | else |

| | | |
|---|---|---|
| 63: | return S* | [symbol] Return a cost-optimal suite. |

| | |
|---|---|
| 64: | end if |

In general, it can be seen that the example Box Suite Recommendation Algorithm 1 of Table 1 generally follows the process described above in conjunction with FIGS. 4-5. Specifically, candidate box dimensions are ordered, and candidate boxes are analyzed to determine nesting capabilities to generate a set of candidate box arrangements that are possible. A fitting matrix is constructed, and packable shipments are determined. Finally, a cost matrix is constructed for solving the p-median problem, resulting in an optimal box assortment for recommendation. A summary of each phase of the above detailed embodiment follows.

### Fitting Matrix

The algorithm begins by sorting each box's dimensions in nonincreasing order. Then, the algorithm determines whether each shipment fits into each candidate box, recording the result in a binary fitting matrix B. The fitting problem when there are 0 or 1 cartons in the shipment is straightforward, and “brute force” algorithms may be used for solving the fitting problem for 2 and 3 cartons in the shipment. Alternatively (or in addition to such “brute force” methods), for 2 or more cartons in the shipment, the algorithm may first attempt to stack the cartons along each of the box's three orthogonal axes, to see if they fit. If simple stacking does not work, then the algorithm uses a feasibility mixed-integer linear program (MILP) to solve the fitting problem. Details regarding an example program are provided below.

### Cost Matrix

Next, the algorithm removes shipments that could not be packed into any candidate box, leaving Î≤I packable shipments. For each packable shipment, Ji⊂J denotes the set of candidate boxes into which packable shipment i fits. Then, the algorithm constructs the nonnegative cost matrix C which records the cost of shipping each packable shipment into each candidate box. If packable shipment i∈Î fits in candidate box j∈J (i.e. if j∈Jᵢ), the cost Cᵢⱼ∈R_{≥0} to ship packable shipment i∈Î in candidate box j∈[J] is computed. Note that in order to compute the cost for packable shipment i∈[I], the data for shipment Wᵢ ∈I is needed; that is, Wi is the shipment index of packable shipment i.

The cost to ship and given shipment in a given carton may be determined, in some examples, by the following, where i represents the shipment and j the carton:

$${C}_{ij} = {ω}_{{s}_{i}} ( max \{ ⌈ {χ}_{{s}_{i} j} [ {L}_{j} ] [ {W}_{j} ] [ {H}_{j} ] ⌉ , ⌈ {Q}_{j} + {q}_{i} ⌉ \} , {ζ}_{i} ) + ⌊ \frac{{\tilde{V}}_{j} - {v}_{i}}{ψ} ⌋ φ + {D}_{j} .$$

As noted previously, sᵢ represents the carrier/service combination for a given shipment, ωₛᵢ represents a lookup table giving cost to ship that shipment i in box j from source to destination as a function of billable weight and shipping zone. Lⱼ, Wⱼ, and Hⱼ are outer dimensions, Qⱼ is the weight of the carton, Dⱼ is the cost of the carton, \tilde{V}ⱼ is the inner volume, and Vⱼ is the outer volume of the carton. Qᵢ and vᵢ are the weight and liquid volume of the shipment i.

The data for shipment Wᵢ∈I may include the outer dimensions and weights of each item, the shipping carrier (e.g. USPS, FedEx, or UPS), the shipping service (e.g. 1 day, 2 day, or 3 day), and the shipping zone, which is determined by the locations of the shipping store or warehouse and the customer. The cost is computed via a detailed formula, noted above, that depends on the shipping cost charged by the carrier and service combination, the cost of the cardboard used to construct the box, the cost to transport the box blank from the box manufacturer to the retailer's stores or warehouses, the cost of the dunnage used to fill the empty space between the packed shipment and the box's interior, and the cost of the tape used to seal the top and bottom flaps of the box shut.

In alternative implementations, if instead of minimizing cost, the online retailer wishes to minimize box outer volume shipped or material weight shipped, then Cᵢⱼ is the outer volume of box j or the weight of the material (cardboard, dunnage, and tape) used to ship packable shipment i in box j, respectively.

Let Γ∈ [symbol] >0∪{∞} be ∞ or a sufficiently large positive real number. Γ serves as a penalty constant to impose constraints on the solution suite S. In order to ensure that the solution suite S ships all the packable shipments, Cᵢⱼ is set to Γ if packable shipment i does not fit in candidate box j. In order to force the boxes in Tinto the solution suite S, k fake shipments are appended to the set of packable shipments and k rows are added to the bottom of C, where each row stores the shipping costs for a fake shipment representing box T_{i-Î}.

p-Median Problem

Once the fitting matrix and cost matrix are prepared, the optimization problem becomes an instance of the p-median problem, or more precisely the p-facility location problem. Given n∈N shipments, m∈N candidate cartons, the nonnegative cost of shipping each shipment, and a fixed p∈m, the p-median problem is to determine a subset of p cartons that ship the shipments in the cartons with minimum cost.

In solving the p-Median problem, a number of constraints are applied, including orientation constraints, containment constraints, nonoverlapping constraints, symmetry breaking constraints, and packing constraints. The p-Median problem may then be solved and applied, as noted below.

### Orientation Constraints

For each carton i∈n, there are 9 orientation binary variables that indicate in which of the 6 possible ways each carton is oriented in the box. lXi, lYi, lZi∈{0, 1} indicate whether the length dimension pi of carton i is parallel to the X-, Y-, or Z-axis, wXi, wYi, wZi∈{0, 1} indicate whether the width dimension qi of carton i is parallel to the X-, Y-, or Z-axis, and hXi, hY i, hZi∈{0, 1} indicate whether the height dimension ri of carton i is parallel to the X-, Y-, or Z-axis.

l_{Xi}+l_{Yi}+l_{Zi}=1 ∀i∈[n],

w_{Xi}+w_{Yi}+w_{Zi}=1 ∀i∈[n],

h_{Xi}+h_{Yi}+h_{Zi}=1 ∀i∈[n],v

l_{Xi}+w_{Xi}+h_{Xi}=1 ∀i∈[n],

l_{Yi}+w_{Yi}+h_{Yi}=1 ∀i∈[n],

l_{Zi}+w_{Zi}+h_{Zi}=1 ∀i∈[n], (4.1)

### Containment Constraints

For each carton i∈[n], (xᵢ, yᵢ, zᵢ)∈R_{≥0}³ denotes the nonnegative coordinates of the lbb corner of carton i. Each carton i∈[n] must be contained in the box, which requires the following 6 linear inequality constraints.

xᵢ≥0 ∀i∈[n],

yᵢ≥0 ∀i∈[n],

zᵢ≥0 ∀i∈[n],

xᵢ+pᵢl_{Xi}+qᵢw_{Xi}+rᵢh_{Xi}≤x∀i∈[n],

yᵢ+pᵢl_{Yi}+qᵢw_{Yi}+rᵢh_{Yi}≤y∀i∈[n],

xᵢ+pᵢl_{Zi}+qᵢw_{Zi}+rᵢh_{Zi}≤x∀i∈[n], (4.2)

### Nonoverlapping Constraints

Every distinct pair of cartons i, k∈n, with i<k, cannot overlap. To enforce these constraints, 6 nonoverlapping binary variables indicate the relative position of pairs of cartons:

aᵢₖ=1 implies that carton i is left of carton k,

bᵢₖ=1 implies that carton i is right of carton k,

cᵢₖ=1 implies that carton i is behind carton k,

dᵢₖ=1 implies that carton i is in front of carton k,

eᵢₖ=1 implies that carton i is below carton k, and

fᵢₖ=1 implies that carton i is on top of carton k.

These constraints are seen in FIG. 7.

In order for cartons i and k to be nonoverlapping, at least one of aᵢₖ, bᵢₖ, cᵢₖ, dᵢₖ, eᵢₖ, and fᵢₖ must be 1. The following 7 linear inequality constraints enforce nonoverlapping of every distinct pair of cartons i and k.

xᵢ+pᵢl_{Xi}+qᵢw_{Xi}+rᵢh_{Xi}≤xₖ+(1−aᵢₖ)x∀i,k∈[n],i<k,

xₖ+pₖl_{Xk}+qₖw_{Xk}+rₖh_{Xk}≤xᵢ+(1−bᵢₖ)x∀i,k∈[n],i<k,

yᵢ+pᵢl_{Yi}+qᵢw_{Yi}+rᵢh_{Yi}≤yₖ+(1−cᵢₖ)y∀i,k∈[n],i<k,

yₖ+pᵢl_{Yk}+qₖw_{Yk}+rₖh_{Yk}≤yᵢ+(1−dᵢₖ)y∀i,k∈[n],i<k,

zᵢ+pᵢl_{Zi}+qᵢw_{Zi}+rᵢh_{Zi}≤zₖ+(1−eᵢₖ)z∀i,k∈[n],i<k,

zₖ+pₖl_{Zk}+qₖw_{Zk}+rₖh_{Zk}≤zᵢ+(1−fᵢₖ)z∀i,k∈[n],i<k,

aᵢₖ+bᵢₖ+cᵢₖ+dᵢₖ+eᵢₖ+fᵢₖ≥1 ∀i,k∈[n],i<k, (4.3)

### Symmetry-Breaking Constraints: Identical Cartons

If some of the n cartons are identical, the carton arrangement is selected such that identical cartons are simply arranged in non-decreasing order (rather than being required to be of different dimensions for order of selection.

### Symmetry-Breaking Constraints: Carton LBB Corner in First Orthant

Let β∈n be the index of a particular carton. For example, β might be the index of the smallest volume carton. If β∈V*, β should be the smallest index of the subset of identical cartons in which β lies. Any feasible packing of the n cartons into the box can be rearranged, through a finite sequence of reflections across the box's 3 inner half-planes, to realize a feasible packing such that the left-back-bottom (lbb) corner of the carton with index β is located in the box's first orthant

$$\{ ( u , v , w ) ∈ {ℝ}_{\geq 0}^{3} \text{:} 0 \leq u \leq \frac{x}{2} , 0 \leq v \leq \frac{y}{2} , 0 \leq w \leq \frac{z}{2} \} \\ {x}_{β} \leq \frac{x}{2} , \\ {y}_{β} \leq \frac{y}{2} , \\ {z}_{β} \leq \frac{z}{2} . \qquad ( 4.5 )$$

### Special Packing Constraints

Some cartons must be packed in special ways, in which case the special packing constraints must be enforced without conflicting with the symmetry-breaking constraints. For example, some cartons cannot be stacked on top of other cartons, so that the Z-coordinates of their lbb corners must equal 0, in which case the constraint zi=0 must be added to the fitting MILP for each such carton i and the third constraint z_{β}≤z in the symmetry-breaking constraints above must be removed, since a feasible packing cannot be reflected across the vertical half-plane. In some cases, such cartons may be referred to as bottom-resting (BR).

As another example, some cartons must be packed vertically, so that their height dimensions must be parallel to the box's Z-axis, in which case the constraint h_{Zi}=1 must be added to the fitting MILP for each such carton i. In some instances, such cartons may be referred to as height-oriented (HO). If there is at least one carton in the shipment that must be height-oriented, then the definition of identical cartons given earlier must be revised in order to construct the subset V for the symmetry-breaking constraints. A pair of cartons i, j∈n, with i/=j, is identical if and only if either of the following conditions is satisfied:

(i) they are both not height-oriented and sort (pᵢ, qᵢ, rᵢ)=sort (pⱼ, qⱼ, rⱼ)

(ii) they are both height-oriented, sort (pᵢ, qᵢ)=sort (pⱼ, qⱼ), and rᵢ=rⱼ.

With this definition of identical cartons, it is still assumed that each subset of identical cartons has been assigned consecutive indices in n and V*⊂n denotes the subset of carton indices in the union of all subsets of identical cartons. In addition, V⊂V * denotes the subset of carton indices such that m∈V if and only if cartons m and m+1 are identical in the new sense.

As a third example, stability may be required for cartons which do not rest on the box's bottom, which requires additional constraints and elimination of the third constraint z_{β}≤^{z} in the symmetry-breaking constraints. This is because a feasible stable packing cannot necessarily be reflected across the vertical half-plane to generate another feasible stable packing (reflecting a stable packing across the vertical half-plane may result in an unstable packing).

In some instances, brute force algorithms can be utilized to fit 2 or 3 items into a carton. However those algorithms must be modified to allow for rotations of the items.

In addition to the above constraints, in order for a shipment to fit into a candidate box, the box's inner volume must be greater than or equal to the shipment's liquid volume and each individual carton in the shipment must fit inside the box. For efficiency, the algorithm checks that these necessary conditions are satisfied first before attempting to solve the stacking problem or fitting MILP when there are 2 or more cartons in the shipment. Moreover, if brute force fitting algorithms for 2 and 3 cartons are available, these may be used to check that all pairs and all triples of cartons fit inside the box before attempting to solve the stacking problem or fitting MILP.

Solving the p-Median Problem

The p-median problem is NP-hard. There are many methods to solve the p-median problem including MILP, Lagrangian relaxation, heuristics (e.g. myopic algorithm, neighborhood search, exchange algorithm, Lin-Kernighan neighborhood exchange algorithm), metaheuristics (e.g. simulated annealing, genetic algorithm, tabu search, heuristic concentration, variable neighborhood search, ant colony optimization, and disperse construction), and hyper-heuristics. In some embodiments, an available solver called “POPSTAR” may be used. That solver is implemented in C++ and solves the p-median problem via a hybrid metaheuristic that combines GRASP with path-relinking and the genetic algorithm. In such embodiments, the solver performs local searches via a fast implementation of the exchange algorithm.

### Validation

The box suite recommendation may be validated by packing the optimization shipment set and a much larger randomly sampled shipment set into the recommended suite S*, where each shipment is assigned to the minimum cost box in the suite into which it fits. Several metrics, such as percentage of shipments packed into each box, percentage of total cost shipped by each box, percentage of all box outer volume shipped by each box, and percentage liquid void space, collected for both packings can be compared. If the metrics are similar, then the cost savings afforded by the recommended suite S* should be expected to hold on all shipments. An alternative validation method is to pack the optimization shipment set and a much larger randomly sampled shipment set into several suites Q∪S*, where each suite S∈Q satisfies T⊂S, |S|=p, and Ji∩S I=Ø∀i∈Î, and ensure that the cost reductions (comparing the cost of each suite S∈Q to the cost of S*) predicted by the optimization shipment set agree with those predicted by the large shipment set. If the various metrics or cost reductions are dissimilar, then the Detailed Algorithm can be run again using a larger set of randomly sampled historical customer shipments.

### Experimental Results

In accordance with the above disclosure, application of the Detailed Algorithm to a historical set of shipment data illustrates significant savings in terms of overall volume and weight reductions, as well as overall cost reduction. In particular, in the example of an eight-carton assortment applied at a retail location to allow for shipments from that retail location in response to online orders, over the course of 20,000 shipments, an outer volume reduction of 7.04% was projected, with a resulting reduction in cardboard weight of 5.74%. Over the course of 160,000 shipments, an outer volume reduction of 6.75% and weight reduction of 5.71% were projected. Similarly, in the context of a distribution center having a 25 carton assortment, over the course of 20,000 shipments, an outer volume reduction of 8.82% and weight reduction of 5.18% were projected, and over 202,000 shipments, an outer volume reduction of 8.24% and weight reduction of 4.85% were projected. Accordingly, it can be seen that significant advantages in terms of physical space consumed, and shipment efficiency, can be realized.

### Advantages

Referring to FIGS. 1-7 generally, the methods and systems described herein provide advantages over existing methods and systems. First, by selecting a particular subset of cartons, less physical space at the facility location will be occupied with cartons waiting to be filled with items. Fewer cartons that are infrequently utilized will be stocked at the facility location. Because a defined number of cartons are selected to be stocked at each facility location, the task of selecting cartons for packaging shipments of items is simplified. By preselecting an optimized assortment of cartons, an employee at a facility location will spend less time determining which carton to use for packaging items. The cartons are selected based on the goals of reducing void space within packed cartons, reducing the overall outer dimensions of cartons, and reducing cardboard weight of cartons. By minimizing these factors, more cartons can be packed onto vehicles for shipment at one time. Thus, greater numbers of items can be shipped at the same time, reducing the overall resources required to complete shipments from a facility location.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method of selecting an assortment of cartons for shipping items from a facility location, the method comprising:
receiving, at a carton selection manager, a shipment history for the facility location, the shipment history including information about a plurality of shipments that were shipped from the facility location over a period of time, wherein each shipment contains one or more items;
receiving, at the carton selection manager, attributes of candidate cartons, the attributes including at least dimensions, weight, and cost of each of the cartons;
for each shipment in the shipment history, determining a subset of the candidate cartons that can contain the one or more items in each shipment;
determining a cost of shipping each shipment in each of the cartons in the subset;
determining a number of carton types to include in the assortment of cartons;
selecting an optimal assortment of cartons from the subset of candidate cartons based at least in part on the cost of shipping and the number of carton types; and
communicating instructions to at least one computing system to stock the assortment of cartons at the facility location.

2. The method of claim 1, further comprising utilizing the assortment of cartons to contain shipments of items at the facility location.

3. The method of claim 1, wherein the facility location is a store or distribution center within a retail supply chain that delivers shipments to customers.

4. The method of claim 1, wherein the information about the shipments includes shipping, dunnage, and carton costs.

5. The method of claim 1, wherein determining which of the candidate cartons can contain the one or more items comprises applying a fitting MILP algorithm.

6. The method of claim 1, wherein determining which of the candidate cartons can contain the one or more items comprises determining that an inner volume of each carton is greater than or equal to a liquid volume of the items in the shipment and determining that each individual item can fit into the carton.

7. The method of claim 1, wherein the calculating of shipping costs comprises adding together carrier costs, carton costs, tape costs, and dunnage costs.

8. The method of claim 1, wherein the number of cartons in the assortment is received from a user selection.

9. The method of claim 1, wherein determining the subset of the candidate cartons that can contain the one or more items in each shipment includes, for at least one shipment determining one or more candidate cartons capable of receiving a height-oriented item for shipment, the height-oriented item having a height dimension being less than or equal to a height of the determined one or more candidate cartons.

10. The method of claim 1, wherein the assortment of cartons is displayed on a graphical user interface on the at least one computing system.

11. The method of claim 1, further comprising repeating the method with an updated shipment history and updating the assortment of cartons.

12. The method of claim 1, further comprising repeating the method for a second facility location and selecting a second assortment of cartons that is different from the optimal assortment of cartons.

13. A system for selecting an assortment of cartons for shipping items from one or more retailer locations, the system comprising:
a processing device;
a data store comprising order histories, carton attributes, shipping cost information, and item attributes; and
a memory device comprising instructions that, when executed by the processing device implement a carton selection manager configured to:
receive shipment histories for the one or more facility locations from the data store, the shipment histories including information about a plurality of shipments that were shipped from the facility locations over a defined period of time, wherein each shipment contains one or more items;
receive attributes of candidate cartons from the data store, the attributes including at least dimensions, weight, and cost of each of the cartons;
for each shipment in the shipment history, determine a subset the candidate cartons that can contain the one or more items in each shipment;
determine a cost of shipping each shipment in each of the cartons in the subset;
determine a number of carton types to include in the assortment of cartons;
select an optimal assortment of cartons from the subset of cartons based at least in part on the cost of shipping and the number of carton types; and
communicate instructions to at least one computing system to stock the assortment of cartons at the facility location.

14. The system of claim 13, wherein determining a subset the candidate cartons that can contain the one or more items in each shipment comprises:
sorting each carton's dimensions in nonincreasing order;
determining that the carton's inner volume is greater than or equal to a liquid volume of the items in the shipment; and
determining that each individual item in the shipment can fit into the carton.

15. The system of claim 14, wherein determining that each individual item in the shipment can fit into the carton comprises at least one of:
determining that either the items can be stacked to fit along one of the orthogonal axes of the carton; or
applying a mixed-integer linear program (MILP) to determine that the items will fit into the carton.

16. The system of claim 13, further comprising recording the combination of carton and shipment in a binary fitting matrix as packable or not packable.

17. The system of claim 13, wherein the cost of shipping is calculated based on carton cost, dunnage cost, tape cost, volume of the carton, and weight of the carton.

18. The system of claim 17, wherein the cost of shipping is further calculated based on a carrier and service combination for the shipment as well as a zone of shipment.

19. The system of claim 13, wherein the optimal assortment of cartons is selected by solving a p-median problem using metaheuristics.

20. The system of claim 13, further comprising a cartonization engine communicatively coupled to the carton selection manager, the cartonization engine being configured to recommend cartons for packaging shipments at each of the one or more facility locations, wherein the cartons are selected from the assortment of cartons.

21. A non-transitory computer-readable storage medium comprising computer-executable instructions which, when executed by a computing system, cause the computing system to perform a method of selecting a carton assortment for a plurality of locations of a retail enterprise, the method comprising:
receiving, at a carton selection manager, a shipment history from a plurality of shipment locations of a retail enterprise, the shipment history including information about a plurality of shipments that were shipped from each of the plurality of locations over a period of time, wherein each shipment contains one or more items;
receiving, at the carton selection manager, attributes of candidate cartons, the attributes including at least dimensions, weight, and cost of each of the cartons;
for each shipment in the shipment history associated with a first location of the plurality of locations, determining a first subset of the candidate cartons that can contain the one or more items in the shipment;
determining first shipping costs associated with each shipment from the first location in each of the determined cartons in the first subset;
selecting, based at least in part on a first predetermined number of cartons to include in the assortment of cartons for the first location and the first shipping costs, a first optimal assortment of cartons from the first subset of candidate cartons;
for each shipment in the shipment history associated with a second location of the plurality of locations, determining a second subset of the candidate cartons that can contain the one or more items in the shipment;
determining second shipping costs associated with each shipment from the second location in each of the determined cartons in the first subset; and
selecting, based at least in part on a second predetermined number of cartons to include in an assortment of cartons for the second location and the second shipping costs, a second optimal assortment of cartons from the second subset of candidate cartons;
wherein the first optimal assortment of cartons and the second optimal assortment of cartons are different from each other.

22. The non-transitory computer-readable storage medium of claim 21, wherein the first predetermined number of cartons is different from the second predetermined number of cartons.

23. The non-transitory computer-readable storage medium of claim 21, wherein the first predetermined number of cartons is the same as the second predetermined number of cartons, and wherein the first optimal assortment of cartons and the second optimal assortment of cartons are different from each other based at least in part on the shipment history associated with the first location and the shipment history associated with the second location.
